(19) United States
(12) Patent Application Publication
(10) Pub. No.: US 2022/0331974 A1
(43) Pub. Date: Oct. 20, 2022

(54) Automatic Lidding and Slice Inversion Tool

(71) Applicant: Active8 Robots Limited, Chilcompton, Radstock Somerset (GB)

(72) Inventors: Antony Lovedale, Chilcompton Somerset (GB); Alan Quinn, Chilcompton Somerset (GB); Jason Clark, Chilcompton Somerset (GB)

(21) Appl. No.: 17/633,088

(22) PCT Filed: Aug. 5, 2020
(86) PCT No.: PCT/EP2020/072070

§ 371 Date: Feb. 4, 2022

(30) Foreign Application Priority Data
Aug. 6, 2019 (GB) 1911262.2

(51) Int. Cl. B25J 11/00; A21C 15/00

(52) U.S. Cl. CPC B25J 11/0045; A21C 15/007

(57) ABSTRACT

An automated sandwich lidding tool is provided and comprises means for placing one slice of bread on top of another.

The present invention relates to a food production tool, for example a robot tool that is designed for use in sandwich production.

A common manual operation on sandwich production lines is ‘lidding’ where one slice of bread is manually placed on top of another to form the typical two slice sandwich.

The present invention seeks to provide improvements in or relating to sandwich assembly.

An aspect of the present invention provides an automated sandwich lidding tool comprising means for placing one slice/piece of bread (e.g. a “lid”) on top of another (e.g. a “base”).

There are two types of lidding: lidding with and without inversion of the bread slice.

Where sandwich contents are pre-assembled only on one slice, slice inversion is not necessarily required before placing.

The term “inversion” may mean that the slice is turned upside down, for example turned through approximately 180 degrees, turned/flipped over or the like actions/movement so that the side of the slice with ingredients on goes from facing upwards to facing downwards.

The sandwich may be a “plain sandwich” e.g. two generally flat/planar slices/pieces of bread (that may or may not be toasted).

Other examples of “slices” include, for example, upper and lower parts of a bun or roll.

Other examples of bread/sandwich types include: brioche; challah; rolls; thin cut slices; thick cut slices; baguettes; oil-based bread; ciabatta; focaccia; rye bread; soda bread; white bread; brown bread; whole grain bread; sourdough bread.

In some aspects and embodiments sandwiches consists of a single upper/lid slice, a single lower/base slice and ingredients (which may optionally include spreads such as butter, margarine, mustard, ketchup, relish or the like).

In these cases, the bread surface can be picked by automatic means, e.g. vacuum cups, as it does not have food content on it.

Where sandwich contents are pre-assembled on both sides of the bread, slice inversion is required. These contents may be, for example, butter, mayonnaise, pre-mixed sandwich pastes, cucumber, tomatoes, protein, cheese, etc.

The tool may comprise means for inverting one slice of bread before placing.

The slice to be inverted may be picked from the underside and an inversion is performed while keeping control of the bread and its contents.

Some embodiments of the present invention provide or relate to the automated lidding of sandwiches with ingredients on both sides, where the challenge is to reliably pick the bread from the underside and perform an inversion while keeping control of the bread and its contents. Inversion with contents in place is thereby made possible.

The tool may have a generally U-shape trajectory when flipping the bread slice, for example by using a combination of axial and rotational movement.

The tool may comprise a pair of spaced arms positionable either side of a slice of bread.

A blade, such as a spatula, may be carried on or by each arm.

The blade may include one or more lid retaining lugs, for example for preventing a slice from falling during inversion.

The blades may be rotatable (whilst a sandwich slice is being lifted, for example).

The arms may include a generally axially movable portion, for example driven by a drive belt and pulley.

The axially movable portions may carry the blades.

The tool may further comprise means for picking a bread slice, for example one or more vacuum cups.

A further aspect provides a bread slice lidding and inversion tool for assembling a sandwich having ingredients on both bread slices.

In aspects and embodiments of the present invention a lid and a base of a sandwich may be located by means of machine vision, and the tool moves to position over the lid slice.

A tool may comprise thin and flexible spatula style blades which deflect in use and allow a pick while not damaging an underlying conveyor.

In some embodiments the spatula blades slide under the slice of bread so it can be lifted off a conveyor belt.

A tool may comprise a rotary actuator for inverting a slice of bread while at maximum lifting velocity to as to control the bread and contents, while simultaneously moving to the position of the base.

A bread slice may also be supported from “above” by retaining lugs, so it does not fall as it is inverted.

In some embodiments the tool rotates to a correct angle to match the base and releases the lid.

Tools formed in accordance with the present invention many be capable of: (i) lifting of a lid slice; ii) rotation of the lid slice; iii) movement of the tool over a base slice; resulting in a generally upturned U-shape path/trajectory for the slice.

The present invention also provides a method of assembling a sandwich as described herein.

The present invention provides a method of assembling a sandwich comprising the steps of: providing a base slice and a lid slice; adding ingredients and/or spread to either or both of the base and the lid; using a tool to assemble the lid on the base.

In some embodiments both the lid and the base are furnished with ingredients and/or spread and in which the lid is inverted to assemble it on the base.

In some embodiments the lid slice follows a generally upturned U-shape trajectory when being assembled onto the base.

The present invention also provides a sandwich assembly line comprising one or more tools as described herein.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims. Each aspect can be carried out independently of the other aspects or in combination with one or more of the other aspects.

The present invention will now be more particularly described, by way of example, with reference to the accompanying drawings.

The example embodiment is described in sufficient detail to enable those of ordinary skill in the art to embody and implement the systems and processes herein described.

It is important to understand that embodiments can be provided in many alternative forms and should not be construed as limited to the examples set forth herein.

There is no intent to limit to the particular form disclosed. On the contrary, all modifications, equivalents, and alternatives falling within the scope of the appended claims should be included. Elements of the example embodiment are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, radially and axially, are used in relation to the drawings and should not be interpreted as limiting on the invention.

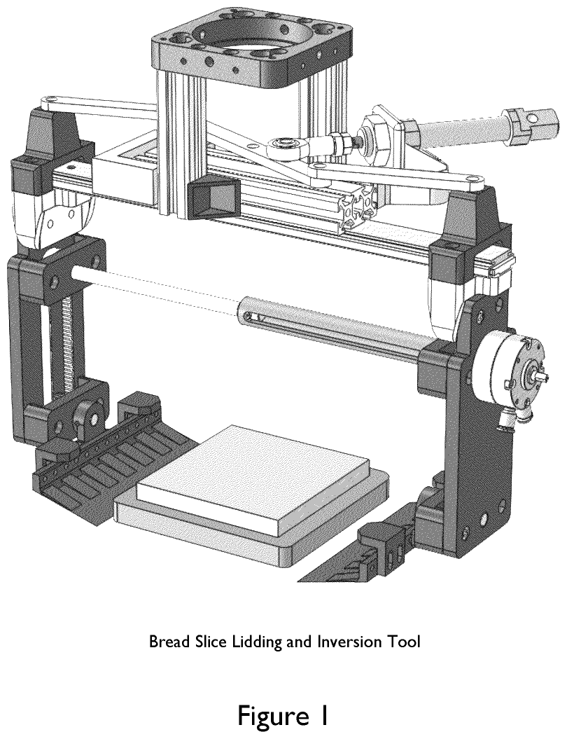

FIG. 1 shows a bread slice lidding and inversion tool formed according to an embodiment of the present invention.

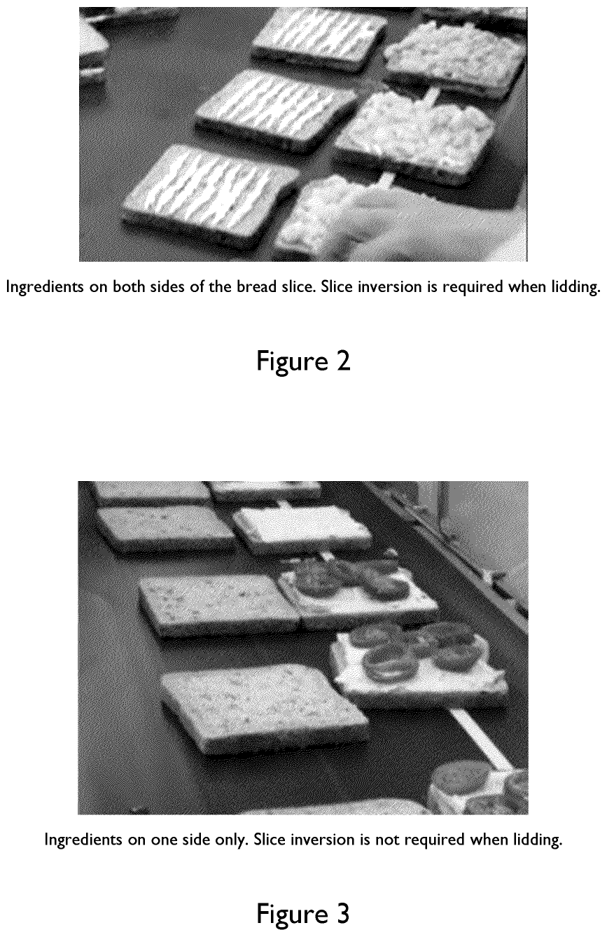

FIG. 2 illustrates a (pre-lidding) unassembled sandwich with ingredients on both sides of the bread slice. Slice inversion is required when lidding.

FIG. 3 illustrates a (pre-lidding) unassembled sandwich with ingredients on one side only. Slice inversion is not required when lidding.

Tool Operation (Also Refer to Drawings for Line and Isometric Drawings)

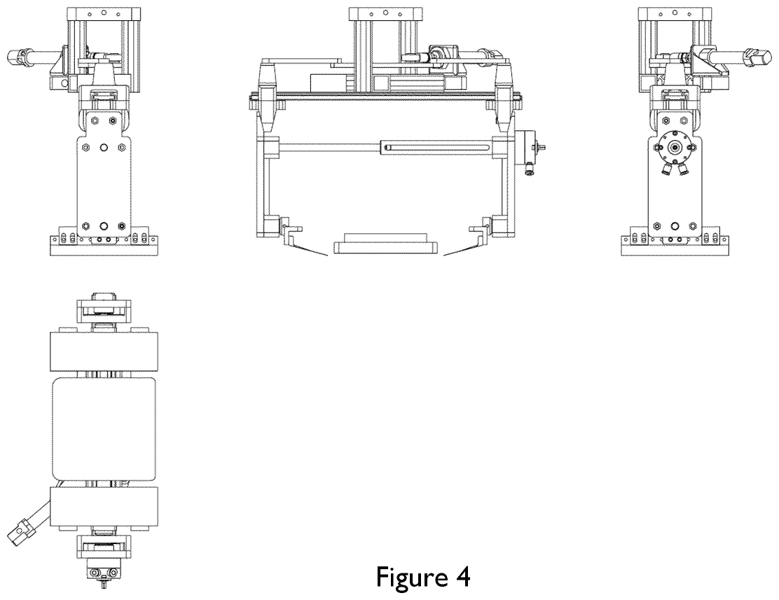

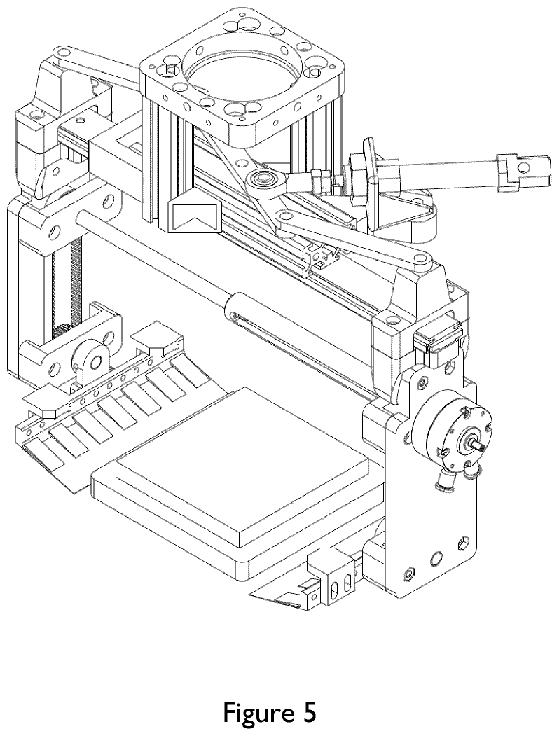

FIGS. 4 & 5—Tool Approach

The lid and base of the sandwich are located by means of machine vision, and the tool moves to position over the lid slice. The thin and flexible spatula style blades deflect and allow a pick while not damaging an underlying conveyor belt.

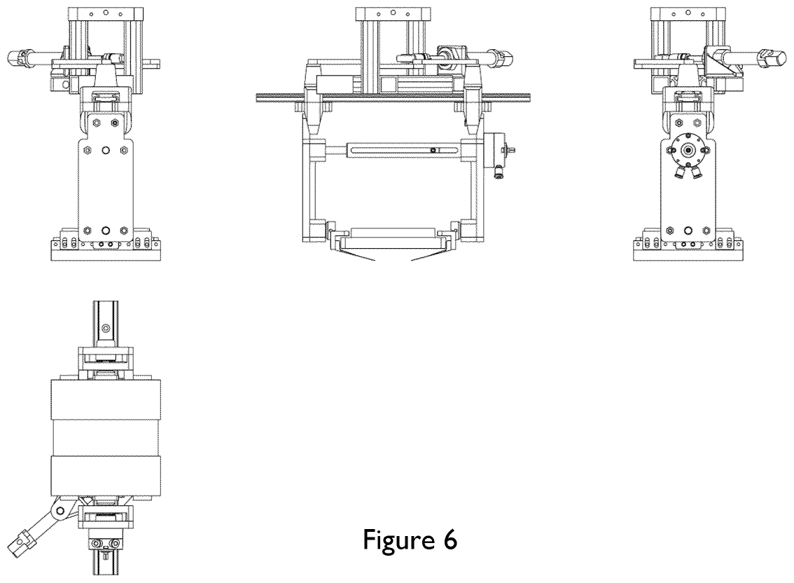

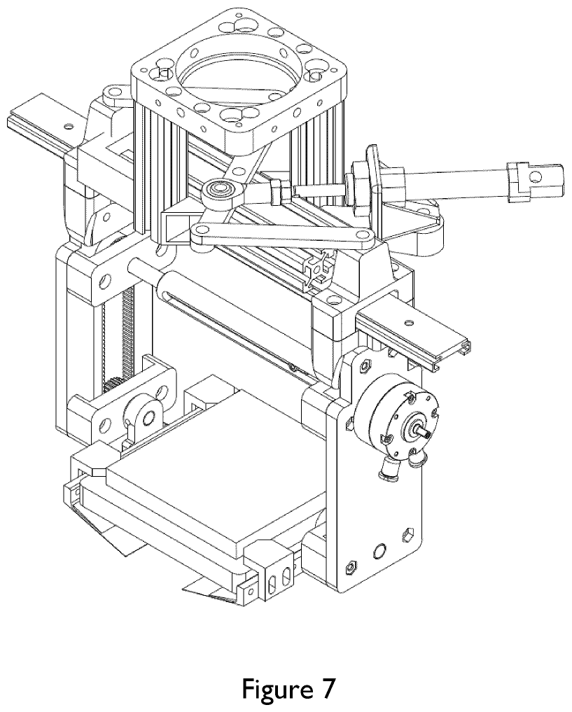

FIGS. 6 & 7—Tool Pick

The spatula blades slide under the slice of bread so it can be lifted off the conveyor belt.

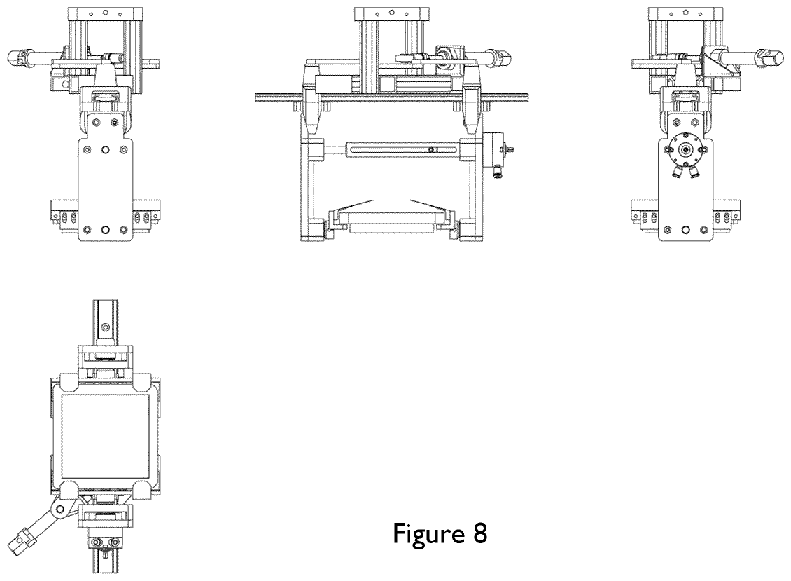

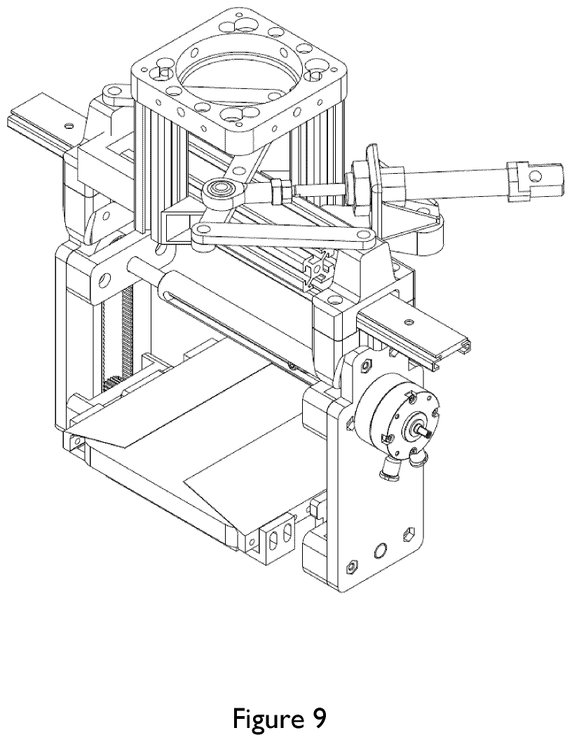

FIGS. 8 & 9—Tool Invert

A rotary actuator inverts the slice of bread while at maximum lifting velocity to as to control the bread and contents, while simultaneously moving to the position of the base. The bread slice is also supported from “above” by retaining lugs (so it does not fall as it is inverted). The simultaneous movements (i) lifting of the slice; ii) rotation of the slice; iii) movement of the tool over the base) result in a generally upturned U-shape path/trajectory for the slice, e.g.:

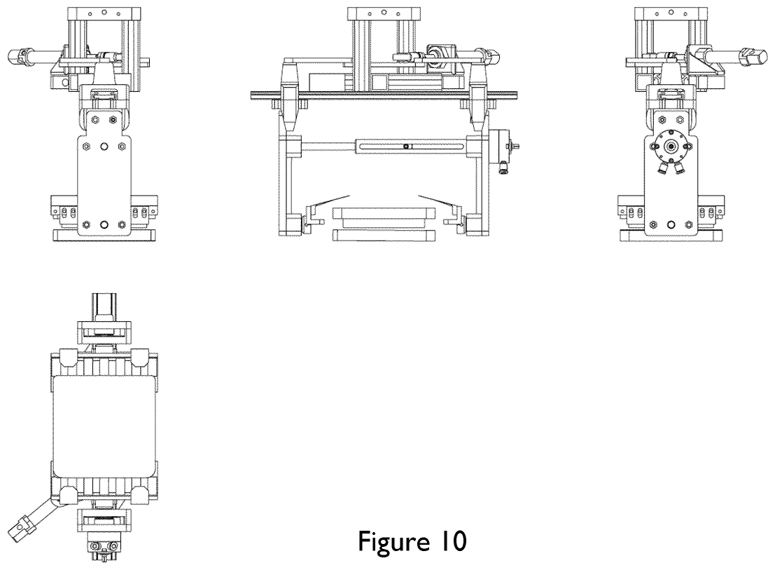

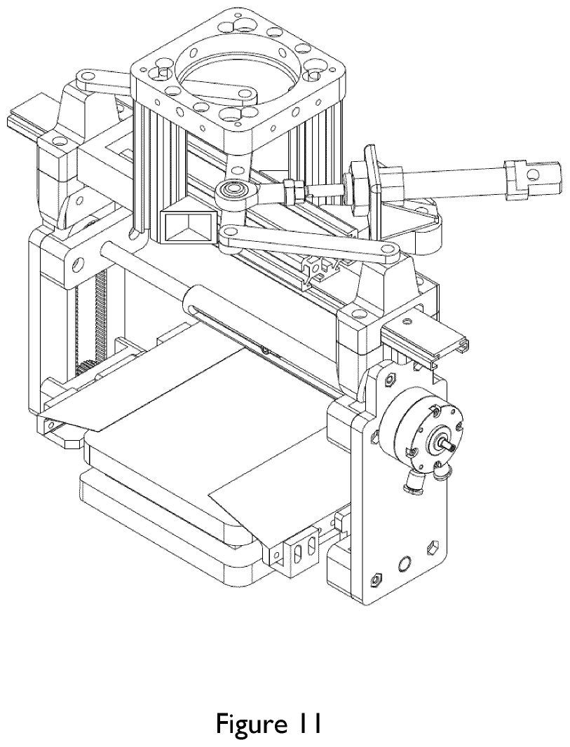

FIGS. 10 & 11—Tool Place and Release

The tool rotates to the correct angle to match the base and releases the lid.

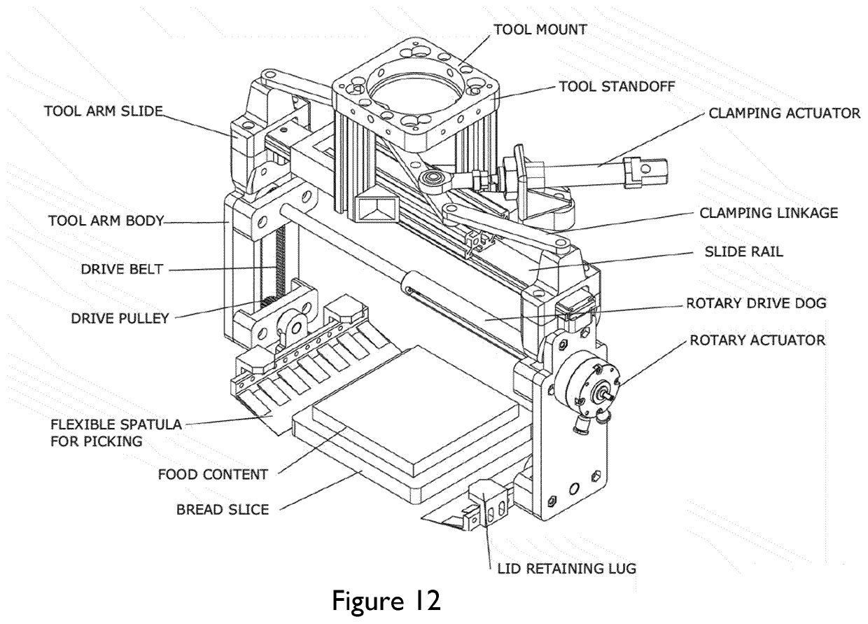

### TOOL ANATOMY (REFER TO FIG. 12)

Parts of the tool include:
Tool Mount
Tool Standoff
Clamping Actuator
Clamping Linkage
Slide Rail
Rotary Drive Dog
Rotary Actuator
Lid Retaining Lug
Flexible Spatula For Picking
Drive Pulley
Drive Belt
Tool Arm Body
Tool Arm Slide

Also shown in FIG. 12:

Bread Slice

Food Content (on an “upper” side of a generally flat bread slice)

Although illustrative embodiments of the invention have been disclosed in detail herein, it is understood that the invention is not limited to the precise embodiments shown and that various changes and modifications can be effected therein by one skilled in the art without departing from the scope of the invention.

1. An automated sandwich lidding tool comprising means for placing one slice of bread on top of another.

2. The tool as claimed in claim 1, further comprising means for inverting one slice of bread before placing.

3. The tool as claimed in claim 2, in which the slice to be inverted is picked from the underside and an inversion is performed while keeping control of the bread and its contents.

4. The tool as claimed in claim 2, in which the tool has a generally U-shape trajectory when flipping the bread slice.

5. The tool as claimed in claim 1, further comprising a pair of spaced arms positionable at either side of a slice of bread.

6. The tool as claimed in claim 5, in which a blade is carried on or by each arm.

7. The tool as claimed in claim 6, in which the blade is a spatula.

8. The tool as claimed in claim 6, in which the blade includes one or more lid retaining lugs.

9. The tool as claimed in claim 6, in which the blades are rotatable.

10. The tool as claimed in claim 5, in which the arms include a generally axially movable portion.

11. The tool as claimed in claim 10, in which the axially movable portions carry the blades.

12. The tool as claimed in claim 1, further comprising means for picking a bread slice.

13. The tool as claimed in claim 12, in which the picking means comprise one or more vacuum cups.

14. (canceled)

15. The tool as claimed in claim 1, in which a lid and a base of a sandwich are located by means of machine vision, and the tool moves to position over the lid slice.

16. The tool as claimed in claim 1, further comprising thin and flexible spatula style blades, which deflect in use and allow a pick while not damaging an underlying conveyor.

17. The tool as claimed in claim 16, in which the spatula blades slide under the slice of bread so it can be lifted off the conveyor belt.

18. The tool as claimed in claim 1, comprising a rotary actuator for inverting a slice of bread while at maximum lifting velocity to as to control the bread and contents, while simultaneously moving to the position of the base.

19. The tool as claimed in claim 1, in which the bread slice is supported from above by retaining lugs, so it does not fall as it is inverted.

20. The tool as claimed in claim 1, wherein the tool is capable of: (i) lifting of a lid slice; (ii) rotation of the lid slice; (iii) movement of the tool over a base slice; resulting in a generally upturned U-shape trajectory for the slice.

21. The tool as claimed in claim 1, in which the tool rotates to a correct angle to match the base and releases the lid.

22-25. (canceled)
